(19) United States
(12) Patent Application Publication
(10) Pub. No.: US 2020/0205051 A1
(43) Pub. Date: Jun. 25, 2020

(54) RELAY STATION APPARATUS, COMMUNICATION SYSTEM, AND METHOD OF COMMUNICATION

(71) Applicant: SHARP KABUSHIKI KAISHA, Sakai City (JP)

(72) Inventors: SHUICHI TAKEHANA, Sakai City (JP); SHIGETO SUZUKI, Sakai City (JP); KENNICHI IIJIMA, Sakai City (JP); MAKOTO YAMAMOTO, Sakai City (JP)

(21) Appl. No.: 16/712,476

(22) Filed: Dec. 12, 2019

(30) Foreign Application Priority Data
Dec. 19, 2018 (JP) 2018-237438

(51) Int. Cl. H04W 36/22; H04W 36/00; H04B 7/155

(52) U.S. Cl. CPC H04W 36/22; H04B 7/15542; H04W 36/0058

(57) ABSTRACT

A relay station apparatus includes a communication unit configured to wirelessly communicate with a terminal apparatus and a base station apparatus, respectively, a first communication control unit configured to control communication with the base station apparatus, and a second communication control unit configured to control communication with the terminal apparatus. The first communication control unit measures a radio environment based on measurement control information received from the base station apparatus and determines whether to change the base station apparatus based on a measurement result of the radio environment. When determining that the base station apparatus need to be changed, the first communication control unit starts processing for changing the base station apparatus. The second communication control unit reduces the volume of communication with the terminal apparatus during the processing for changing the base station apparatus from a communication volume before the processing for changing the base station apparatus.

### BACKGROUND

### 1. Field

The present disclosure relates to a relay station apparatus, a communication system, and a method of communication.

### 2. Description of the Related Art

The third generation partnership project (3GPP) TSG RAN2 (Technical Specification Group Radio Access Network 2) considers standardized specifications of conditional handover (CHO) (see Huawei, HiSilicon, “Analysis on conditional handover”, [online], Mar. 24, 2017, 3GPP TSG-RANWG2 #97bis, Spokane USA, [Nov. 27, 2018], on the Internet [URL: http://www.3gpp.org/ftp/tsg_ran/WG2_RL2/TSGR2_97bis/Docs/]). CHO has the advantage of reducing delay due to processing and the probability of radio link failure (RLF) as compared with normal handover (HO).

In CHO, a base station apparatus (gNB: gNodeB) selects one or a plurality of candidates of a destination base station apparatus (hereinafter referred to as “candidate base station apparatus”) based on a measurement report from a connected terminal apparatus (UE: user equipment) and transmits a CHO command to the selected candidate base station apparatus. The candidate base station apparatus that has received the CHO command reserves radio resources in preparation for a handover request from the terminal apparatus. The terminal apparatus selects a target cell of the destination base station apparatus from the candidate base station apparatuses on the basis of the radio wave reception state and requests handover from the selected target cell.

Some transportations such as trains are equipped with a relay station apparatus to provide a communication service to terminal apparatuses carried by the passengers. The relay station apparatus may relay communication between the terminal apparatuses and the donor base station apparatus and change the destination donor base station apparatus with the movement of the transportations. In that case, it is necessary to reserve resources for use in communication between the terminal apparatus and the connected relay station apparatus also for the destination donor base station apparatus. This may raise a possibility that the destination donor base station apparatus will run out resources to fail in CHO.

### SUMMARY

According to an aspect of the disclosure, there is provided a relay station apparatus including a communication unit configured to wirelessly communicate with a terminal apparatus and a base station apparatus, respectively, a first communication control unit configured to control communication with the base station apparatus, and a second communication control unit configured to control communication with the terminal apparatus. The first communication control unit measures a radio environment based on measurement control information received from the base station apparatus and determines whether to change the base station apparatus based on a measurement result of the radio environment. When determining that the base station apparatus need to be changed, the first communication control unit starts processing for changing the base station apparatus. The second communication control unit reduces the volume of communication with the terminal apparatus during the processing for changing the base station apparatus from a communication volume before the processing for changing the base station apparatus.

### Advantageous Effects of Invention

An aspect of the disclosure advantageouslychangs base station apparatuses more reliably to continue communication.

### BRIEF DESCRIPTION OF THE DRAWINGS

FIG. 1 is a conceptual diagram illustrating a communication system according to a first embodiment;

FIG. 2 is a block diagram illustrating an example configuration of a relay station apparatus according to the first embodiment;

FIG. 3 is a schematic block diagram illustrating an example configuration of a first base station apparatus according to the first embodiment;

FIG. 4 is a schematic block diagram illustrating an example configuration of a second base station apparatus according to the first embodiment;

FIG. 5 is a block diagram illustrating an example configuration of a terminal apparatus according to the first embodiment;

FIG. 6 is a sequence chart illustrating an example of communication processing according to the first embodiment;

FIG. 7 is a graph illustrating an example of the communication volume before and after CHO processing according to the first embodiment;

FIG. 8 is a sequence chart illustrating an example of communication processing according to a second embodiment; and

FIG. 9 is a sequence chart illustrating an example of communication processing according to a third embodiment.

### DESCRIPTION OF THE EMBODIMENTS

### First Embodiment

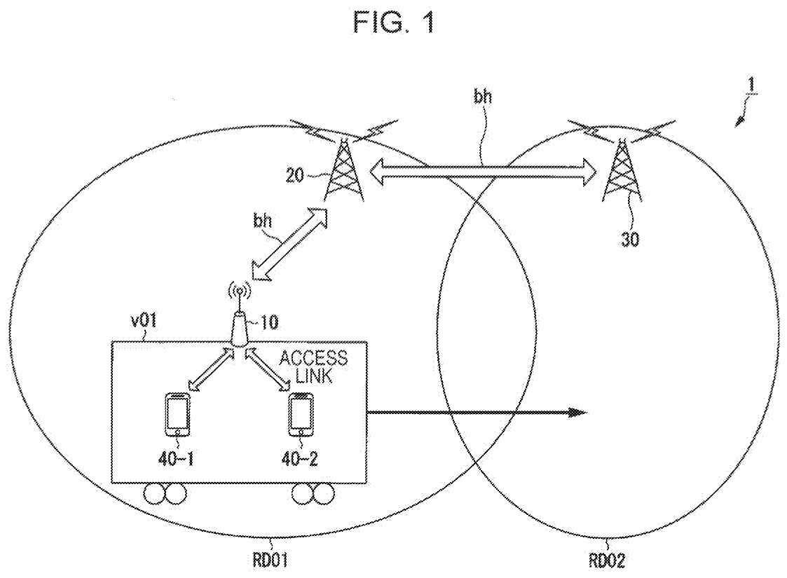

A first embodiment of the present disclosure will be described, in outline, with reference to the drawings. First, a communication system 1, which is an example of a communication system according to the present embodiment, will be described in outline. FIG. 1 is a conceptual diagram illustrating the communication system according to the present embodiment. The communication system 1 includes at least one relay station apparatus 10 and a plurality of donor base station apparatuses. The plurality of donor base station apparatuses are connected to each other through a backhaul link bh.

The relay station apparatus 10 is installed in a mobile object v01 and relays communication between one or a plurality of terminal apparatuses 40, which are carried by the passengers of the mobile object v01 or mounted on the mobile object v01, and donor base station apparatuses that cover the relay station apparatus 10 within the coverages thereof (hereinafter referred to as “within the coverage area”). In other words, the relay station apparatus 10 provides the terminal apparatuses 40 with an access link to the communication system 1. The coverage refers to a range in which various signals can be transmitted to and received from other apparatuses. In the example illustrated in FIG. 1, the number of terminal apparatuses 40 is two. The two terminal apparatuses 40 are distinguished using reference signs 40-1 and 40-2. The number of terminal apparatuses connected to the relay station apparatus 10 can be generally zero, one, or three or more. Examples of the mobile object v01 include vehicles for transportation, such as a train and an omnibus (bus). Accordingly, the relay station apparatus 10 can satisfy a request for high-speed data communication using terminal apparatuses that the passengers of the mobile object v01 carry.

The donor base station apparatuses are base station apparatuses (gNB) that provide the terminal apparatuses 40 connected to the relay station apparatus 10 located within the coverage areas of the donor base station apparatuses with a radio communication service. In the example illustrated in FIG. 1, the number of donor base station apparatuses is two. The two donor base station apparatuses are referred to as a first base station apparatus 20 and a second base station apparatus 30 for distinction. The coverages of the first base station apparatus 20 and the second base station apparatus 30 are referred to as a coverage RD01 and a coverage RD02, respectively. The number of donor base station apparatuses can be generally three or more.

FIG. 1 illustrates a case in which the mobile object v01 moves to an area within the coverage RD01 but out of the coverage RD02, an area in which the coverages RD01 and RD02 overlap, and an area within the coverage RD02 but out of the coverage RD01 in sequence. Accordingly, the relay station apparatus 10 needs to switch the donor base station apparatuses to provide stable communication. Switching the base station apparatuses for use in communication (hereinafter referred to as “serving base station apparatuses) is referred to as handover (HO). In a handover processing period, data communication is interrupted. To reduce the interruption period and to decrease the possibility of failure in handover, the use of conditional handover (CHO) is effective. The volume of communication between the terminal apparatus 40 and the serving base station apparatus is generally larger via the relay station apparatus 10 than the volume of direct communication. For this reason, the destination base station apparatus in CHO (hereinafter referred to as “destination base station apparatus” or “target base station apparatus”) needs more resources for the communication via the relay station apparatus 10. In the present embodiment, the relay station apparatus 10 decreases the speed of communication with the terminal apparatus 40 connected to the relay station apparatus 10 during the period of CHO processing.

### Relay Station Apparatus

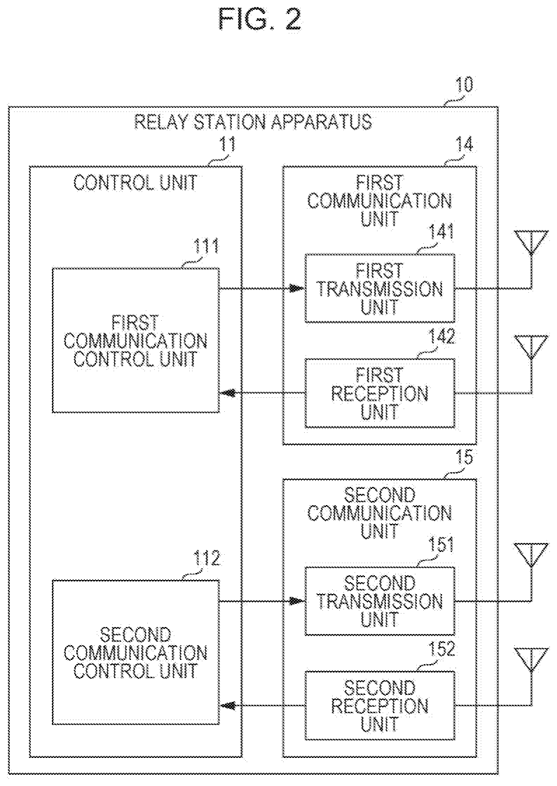

Next, an example configuration of the relay station apparatus 10 according to the present embodiment will be described. FIG. 2 is a block diagram illustrating an example configuration of the relay station apparatus 10 according to the present embodiment. The relay station apparatus 10 includes a control unit 11, a first communication unit 14, and a second communication unit 15. The control unit 11 provides the functions of the relay station apparatus 10 and performs control related to the functions. The control unit 11 may include processors, such as one or more central processing unit (CPU), and storage media, such as a random access memory (RAM) and a read only memory (ROM). The processor may implement the functions of the control unit 11, described below, by reading programs stored in the storage media and performing processing indicated by instructions written in the read programs. In this application, performing processing indicated by instructions written in the read programs is sometimes referred to as “executing the program”.

The control unit 11 includes a first communication control unit 111 and a second communication control unit 112. The first communication control unit 111 controls the operation of the first communication unit 14, that is, performs processing for communication with the donor base station apparatuses (including the serving base station apparatus). For example, the first communication control unit 111 performs control for connection with the donor base station apparatuses, control for receiving data transmitted from the donor base station apparatuses and transmitting the received data to the second communication unit 15 as transmission data, control for transmitting data input from the second communication unit 15 to the donor base station apparatuses as transmission data, and control of the carrier frequency of the first communication unit 14.

The first communication control unit 111 measures the radio environment of the relay station apparatus 10 on the basis of measurement control information received from the serving base station apparatus. More specifically, the first communication control unit 111 extracts measurement control information from the signal received from the serving base station apparatus. The measurement control information includes reference signal setting indicating the reference signal of each base station apparatus to be measured and HO condition information indicating predetermined conditions (hereinafter referred to as HO conditions) for switching serving base station apparatuses. The measurement control information also includes reference signals transmitted from the cells of the individual neighboring base station apparatuses to be measured, in addition to the serving base station apparatus. The neighboring base station apparatuses refer to donor base station apparatuses installed within a predetermined range from the serving base station apparatus. An example of the HO conditions is the condition that when the reception quality of a reference signal transmitted from the cell of any one of the neighboring base station apparatuses is higher than the quality obtained by correcting the reception quality of a reference signal transmitted from the cell of the serving base station apparatus, the cell of the one neighboring base station apparatus is set as the cell of a candidate base station apparatus, which is a candidate of the destination base station apparatus.

The first communication control unit 111 measures the reception quality of each reference signal designated by reference signal setting as a measurement result and determines whether the measurement results satisfy the HO conditions. Examples of an applicable index for the reception quality include reception power, a signal-to-interference-plus-noise ratio (SINR), a block error rate, a frame error rate, and a throughput. If the first communication control unit 111 determines that the measurement result satisfies the HO conditions, the first communication control unit 111 generates a measurement report indicating the measurement result for each reference signal. The first communication control unit 111 transmits the generated measurement report to the serving base station apparatus. Accordingly, the measurement report can be regarded as CHO request information indicating a CHO request. When the first communication control unit 111 transmits the measurement report to the serving base station apparatus, the first communication control unit 111 outputs CHO start notification information indicating the start of CHO processing to the second communication control unit 112. If the first communication control unit 111 determines that the measurement result does not satisfy the HO conditions, the first communication control unit 111 generates and transmits no measurement report.

Thereafter, when the first communication control unit 111 receives CHO instruction information ordering CHO from the serving base station apparatus, the first communication control unit 111 performs processing for connecting to the destination base station apparatus. The first communication control unit 111 specifies the base station apparatus indicated by destination base station apparatus information contained in the CHO instruction information as the destination base station apparatus. The first communication control unit 111 disconnects the serving base station apparatus connected until that point in time. After completion of the processing for connecting to the destination base station apparatus, the first communication control unit 111 transmits CHO-completion notification information indicating the completion of the CHO processing to the destination base station apparatus and to the second communication control unit 112. Thereafter, the control unit 11 performs communication using resources indicated by resource information contained in the received CHO instruction information.

The second communication control unit 112 performs control related to communication with the terminal apparatuses 40. Here, the second communication control unit 112 controls the operation of the second communication unit 15. For example, the second communication control unit 112 performs control for processing for connecting to the terminal apparatuses 40, receiving data transmitted from the terminal apparatuses 40 and transmitting the received data to the second communication unit 15 (for example, including demodulation and decoding), control for transmitting data input from the second communication unit 15 to the terminal apparatus 40 (for example, including coding and modulation), allocation of resources for the communication with the terminal apparatuses 40, and control of the carrier frequency of the second communication unit 15.

When the second communication control unit 112 receives the CHO start notification information from the first communication control unit 111, the second communication control unit 112 performs first data-rate change processing for reducing the amount of data transferred by the resources allocated to communication with each terminal apparatus 40 (hereinafter referred to as “communication volume”) from the communication volume before the start of the CHO processing. In the first data-rate change processing, the second communication control unit 112 reduces the amount of resources allocated to each of the terminal apparatus 40 (hereinafter referred to as “resource amount”) from the amount before the start of the CHO processing. The second communication control unit 112 generates data-rate change instruction information indicting the reduction of the communication volume, including resource information indicating the reduced resources and transmits the generated data-rate change instruction information to each terminal apparatus 40. When the second communication control unit 112 receives acknowledgement information (ACK) from any of the terminal apparatuses 40 in response to the data-rate change instruction information, the second communication control unit 112 continues the communication with the terminal apparatus 40, which is the transmission source of the acknowledgement information, using the reduced resources.

In the first data-rate change processing, the second communication control unit 112 may increase the information densities of the transmission data and received data transmitted to and received from the terminal apparatuses 40 (hereinafter collectively referred to as “communication data”). When reducing the communication volume, the second communication control unit 112 increases, for example, a modulation and coding scheme (MCS) index value indicating a combination of a communication data coding scheme and a communication data modulation scheme from that before the start of the CHO processing. The greater MCS value indicates that the combination of the coding scheme and the modulation scheme increases the product of the coding rate of the coding scheme and the modulation multilevel number of the modulation scheme, in other words, the amount of information of the coded and modulated data per unit resource amount (that is, information density). Thus, increasing the MCS value may substantially prevent or reduce a decrease in the information amount of communication data transferred. The second communication control unit 112 transmits the data-rate change instruction information including the increased MCS value to the terminal apparatus 40. When the second communication control unit 112 receives acknowledgement information (ACK) from any of the terminal apparatuses 40, the second communication control unit 112 codes the transmission data using a coding scheme indicated by the increased MCS value and decodes demodulated received data using a decoding scheme corresponding to the coding scheme. The second communication control unit 112 modulates the coded transmission data using a modulation scheme indicated by the MCS value and demodulates the received data using a demodulation scheme corresponding to the modulation scheme.

After the second communication control unit 112 receives the CHO-completion notification information from the first communication control unit 111, the second communication control unit 112 executes second data-rate change processing for recovering the communication volume of each terminal apparatus 40 to a communication volume before the start of the CHO processing. This increases the reduced communication volume to the original communication volume before the CHO processing. In the second data-rate change processing, the second communication control unit 112 increases the amount of resources allocated to the communication with each terminal apparatus 40 to the amount of resources before the start of the CHO processing. The second communication control unit 112 transmits data-rate change instruction information indicating the restoration of the communication volume, including resource information indicating the increased resources, to each of the terminal apparatuses 40. When the second communication control unit 112 receives acknowledgement information (ACK) from any one of the terminal apparatuses 40 in response to the data-rate change instruction information, the second communication control unit 112 continues the communication with the terminal apparatus 40, which is the transmission source of the acknowledgement information, using the increased resources.

If the information density of the communication data is increased in the first data-rate change processing, then in the second data-rate change processing, the second communication control unit 112 may reduce the information density of the communication data to the information density before the start of the CHO processing. The second communication control unit 112 transmits data-rate change instruction information including the MCS value decreased to the value before the start of the CHO processing to each of the terminal apparatuses 40. When the second communication control unit 112 receives acknowledgement information (ACK) from any of the terminal apparatuses 40, the second communication control unit 112 codes the transmission data using a coding scheme indicated by the decreased MCS value and decodes the demodulated received data using a decoding scheme corresponding to the coding scheme. The second communication control unit 112 modulates the coded transmission data using a modulation scheme indicated by the MCS value and demodulates the received data using a demodulation scheme corresponding to the modulation scheme.

The first communication unit 14 transmits and receives various data to and from the donor base station apparatuses wirelessly using a predetermined radio communication system (for example, 5G [5th generation mobile telecommunication system]). The first communication unit 14 includes a first transmission unit 141 and a first reception unit 142. The first transmission unit 141 transmits transmission data (upstream) input from the control unit 11 to the donor base station apparatuses wirelessly using an antenna. The first reception unit 142 receives incoming data (downstream) transmitted from the donor base station apparatuses wirelessly using an antenna and outputs the received data to the control unit 11. The second communication unit 15 transmits and receive various data to and from the terminal apparatuses 40 present in the coverage of the relay station apparatus 10 using a predetermined radio communication system. The second communication unit 15 includes a second transmission unit 151 and a second reception unit 152. The second transmission unit 151 transmits transmission data (downstream) input from the control unit 11 to the terminal apparatuses 40 wirelessly using an antenna. The second reception unit 152 receives incoming data (upstream) transmitted from the terminal apparatuses 40 wirelessly using an antenna and outputs the received data to the control unit 11. The first communication unit 14 and the second communication unit 15 each include, for example, a radio communication interface.

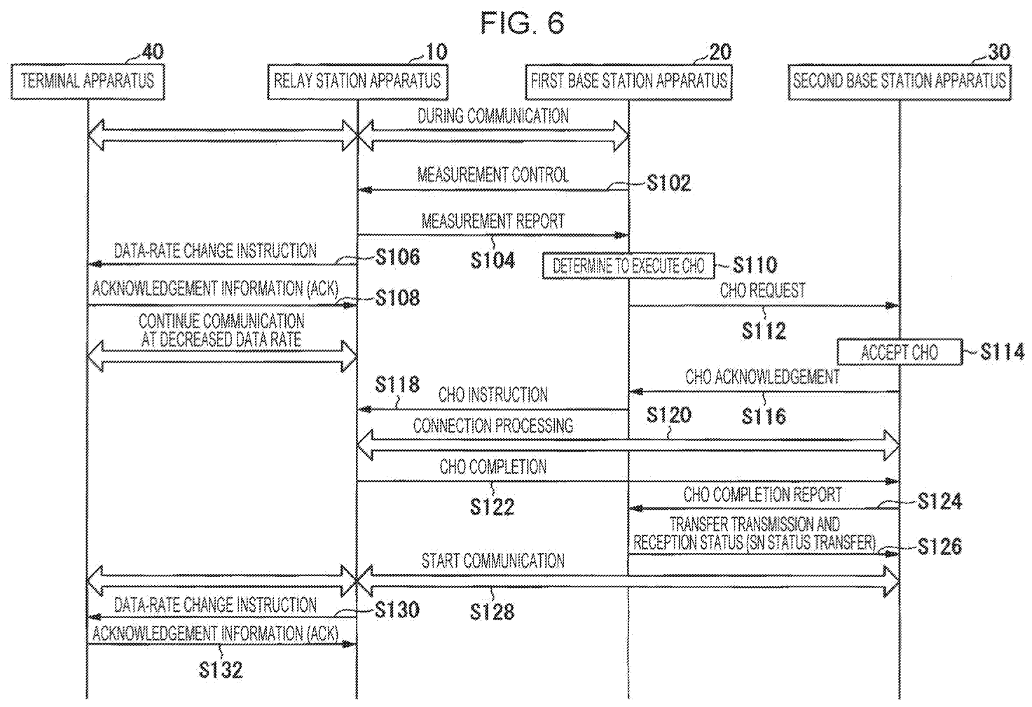

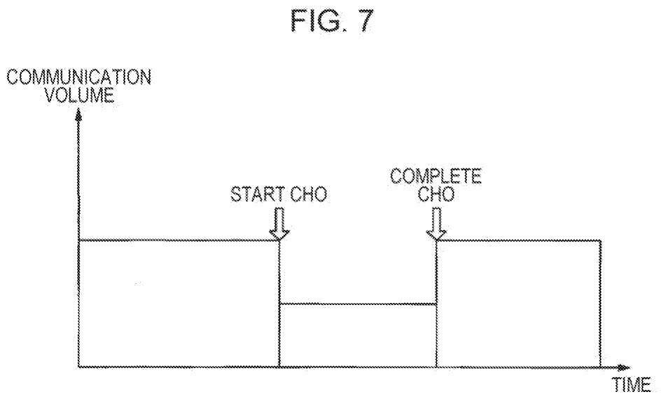

According to the processing illustrated in FIG. 6 (described below), the relay station apparatus 10 according to the present embodiment can reduce the volume of communication with the terminal apparatuses 40 during the CHO processing, that is, during the period from the start of CHO to the completion of CHO while maintaining connection to the terminal apparatuses 40 to provide an access link and can restore the communication volume after completion of the CHO processing. In the example illustrated in FIG. 7, the communication volume during CHO processing is about half the communication volume before and after the CHO processing. This reduces the amount of resources to be reserved for the second base station apparatus 30, which is the destination base station apparatus, to communicate with the relay station apparatus 10. Furthermore, executing CHO with more reliability allows providing the terminal apparatuses 40 with a stable communication service. This also reduces the amount of data retained at the relay station apparatus 10 during CHO processing. This allows the communication between the relay station apparatus 10 and the destination base station apparatus after the CHO processing to be restarted smoothly.

### Base Station Apparatus

Next, an example configuration of the donor base station apparatuses according to the present embodiment will be described. In the following description, a serving base station apparatus connected to the relay station apparatus 10 at the point in time is the first base station apparatus 20, and one of the neighboring base station apparatuses of the first base station apparatus 20 is the second base station apparatus 30. In the description below, the first base station apparatus 20 and the second base station apparatus 30 respectively mainly serve as a serving base station apparatus (hereinafter referred to as “source base station apparatus”) and a destination base station apparatus. The first base station apparatus 20 and the second base station apparatus 30 may respectively have the configuration of the second base station apparatus 30 and the configuration of the first base station apparatus 20.

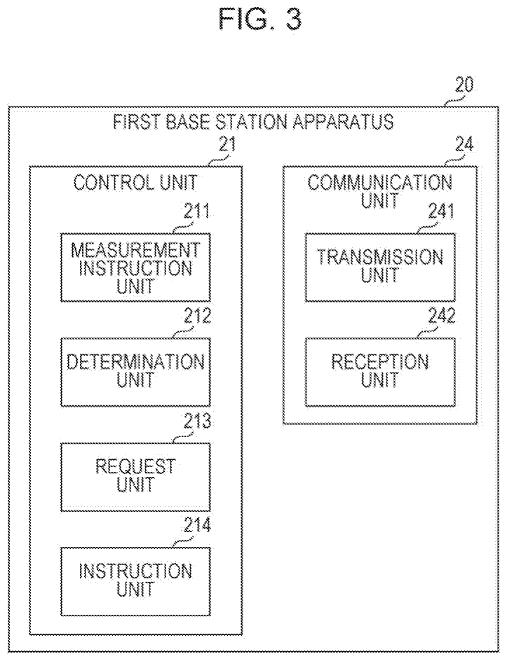

FIG. 3 is a schematic block diagram illustrating an example configuration of the first base station apparatus 20 according to the present embodiment. The first base station apparatus 20 includes a control unit 21 and a communication unit 24. The control unit 21 provides the functions of the first base station apparatus 20 and performs control related to the functions. The control unit 21 may include, for example, one or more processors and storage media. The processors may read programs stored in a storage medium and execute the read programs to implement the functions of the control unit 21 described below. The control unit 21 includes a measurement instruction unit 211, a determination unit 212, a request unit 213, and an instruction unit 214.

The measurement instruction unit 211 generates measurement control information indicating an instruction to measure the quality of communication of the first base station apparatus 20 and the neighboring base station apparatuses with the relay station apparatus 10. The measurement instruction unit 211 transmits the generated measurement control information to the relay station apparatus 10 using the communication unit 24. The timing when the measurement instruction unit 211 generates and transmits the measurement control information may be at predetermined intervals or when any of measurement results indicated by the measurement report received from the relay station apparatus 10 satisfies predetermined HO conditions.

The determination unit 212 waits for a measurement report, which reports the communication quality of each measurement object indicated by the measurement control information, from the relay station apparatus 10 using the communication unit 24. When the determination unit 212 receives the measurement report from the relay station apparatus 10, the determination unit 212 specifies a base station apparatus in a cell that is the transmission source of a reference signal whose reception quality satisfies the HO conditions, as a candidate base station apparatus, from the reception quality, which is the measurement result of a reference signal for each base station apparatus, indicated by the received measurement report. If one candidate base station apparatus is specified, the determination unit 212 determines the specified candidate base station apparatus as the determination base station apparatus and specifies the second base station apparatus 30 to execute CHO. If a plurality of candidate base station apparatuses are specified, the determination unit 212 determines one of the plurality of candidate base station apparatuses, for example, a candidate base station apparatus in a cell that is the transmission source of a reference signal whose reception quality is highest as the destination base station apparatus and specifies the second base station apparatus 30 to execute CHO. The determination unit 212 outputs CHO execution determination information indicating an instruction for the second base station apparatus 30 to execute CHO to the request unit 213.

When the request unit 213 receives the CHO execution determination information from the determination unit 212, the request unit 213 generates CHO request information indicating an instruction to execute CHO. The request unit 213 transmits the generated CHO request information to the second base station apparatus 30, which is the destination base station apparatus indicated by the execution determination information using the communication unit 24.

The instruction unit 214 waits for CHO acknowledgement information from the second base station apparatus 30, which is the destination base station apparatus, as a response to the CHO request information transmitted from the request unit 213. When the instruction unit 214 receives the CHO acknowledgement information using the communication unit 24, the instruction unit 214 extracts resource information contained in the CHO acknowledgement information. The instruction unit 214 generates CHO instruction information indicating an instruction to execute CHO, including the extracted resource information, to the second base station apparatus 30, which is the destination base station apparatus. The instruction unit 214 transmits the generated CHO instruction information to the relay station apparatus 10 using the communication unit 24. The instruction unit 214 waits for CHO completion report information from the second base station apparatus 30, which is the destination base station apparatus. When the instruction unit 214 receives the CHO completion report information using the communication unit 24, the instruction unit 214 transmits transmission and reception status information (SN Status Transfer) indicating the status of transmission and reception of various data to and from the terminal apparatuses 40 to the second base station apparatus 30, which is the destination base station apparatus.

The communication unit 24 transmits and receives various data to and from the relay station apparatuses 10 within the coverage of the first base station apparatus 20 using a predetermined wireless communication system. The communication unit 24 transmits and receives various data wirelessly or by wire to and from other base station apparatuses in the network to which the first base station apparatus 20 belongs via a backhaul link connected to the first base station apparatus 20. The communication unit 24 includes a transmission unit 241 and a reception unit 242. The transmission unit 241 transmits transmission data (downstream) input from other base station apparatuses using the control unit 21 to the relay station apparatus 10 wirelessly using an antenna. The reception unit 242 receives data (upstream) transmitted wirelessly from the relay station apparatus 10 using an antenna and transmits the received data to other base station apparatuses using the control unit 21. The communication unit 24 includes, for example, a wireless communication interface.

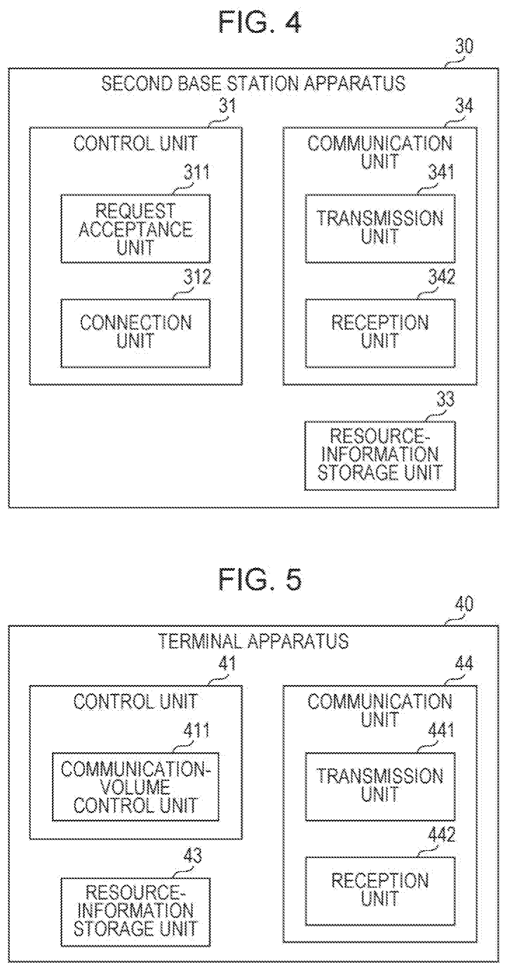

FIG. 4 is a schematic block diagram illustrating an example configuration of the second base station apparatus 30 according to the present embodiment. The second base station apparatus 30 includes a control unit 31, a resource-information storage unit 33, and a communication unit 34. The control unit 31 provides the functions of the second base station apparatus 30 and performs control related to the functions. The control unit 31 may include, for example, one or more processors and storage media. The processors may read programs stored in a storage medium and execute the read programs to implement the functions of the control unit 31 described below. The control unit 31 includes a request acceptance unit 311 and a connection unit 312.

The request acceptance unit 311 waits for the CHO request information from the first base station apparatus 20, which is another base station apparatus, using the communication unit 34. When receiving the CHO request information, the request acceptance unit 311 performs CHO acceptance processing. The CHO acceptance processing is processing for the second base station apparatus 30 to operate as the destination base station apparatus in CHO. Examples of the CHO acceptance processing include changing the communication channel from the source base station apparatus to the second base station apparatus 30 in the network constituting the communication system 1, preallocating resources newly necessary for communication with the relay station apparatus 10, and various negotiations with the first base station apparatus 20, which is the source base station apparatus involved therein. Upon completion of the CHO acceptance processing, the request acceptance unit 311 generates CHO acknowledgement information including resource information indicating the allocated resources. The request acceptance unit 311 transmits the generated CHO acknowledgement information as a response to the CHO request information to the first base station apparatus 20, which is the source base station apparatus, using the communication unit 34. The request acceptance unit 311 stores the resource information in the resource-information storage unit 33 in association with the apparatus identification information on the relay station apparatus 10. The request acceptance unit 311 outputs CHO acceptance notification information indicating completion of the CHO acceptance processing to the connection unit 312.

When the connection unit 312 receives the transmission and reception status information from the first base station apparatus 20, which is the source base station apparatus, using the communication unit 34, the connection unit 312 performs processing for connecting to the relay station apparatus 10 to establish connection to the relay station apparatus 10. Thereafter, when the connection unit 312 receives the CHO-completion notification information from the relay station apparatus 10 using the communication unit 34, the connection unit 312 transmits the CHO completion report information indicating completion of the CHO processing to the first base station apparatus 20, which is the source base station apparatus, using the communication unit 34. When the control unit 31 receives the transmission and reception status information from the first base station apparatus 20 using the communication unit 34, the control unit 31 reads resource information stored in the resource-information storage unit 33 and starts communication with the relay station apparatus 10 using resources indicated by the read resource information. The resource-information storage unit 33 stores apparatus identification information on each apparatus (including the relay station apparatus 10) that communicates with the second base station apparatus 30 wirelessly and resource information indicating resources allocated to communication with the apparatus in association with each other.

The communication unit 34 transmits and receives various data to and from the relay station apparatus 10 within the coverage of the second base station apparatus 30 wirelessly using a predetermined wireless communication system. The communication unit 34 transmits and receives various data to and from other base station apparatuses in the network to which the second base station apparatus 30 belongs wirelessly or by wire via a backhaul link connected to the second base station apparatus 30. The communication unit 34 includes a transmission unit 341 and a reception unit 342. Since the configurations and functions of the communication unit 34 and the transmission unit 341 and the reception unit 342 thereof are the same as the configurations and functions of the communication unit 24 and the transmission unit 241 and the reception unit 242 thereof, the descriptions will be quoted.

### Terminal Apparatus

Next, an example configuration of the terminal apparatuses 40 according to the present embodiment will be described. FIG. 5 is a block diagram illustrating an example configuration of each terminal apparatus 40 according to the present embodiment. The terminal apparatus 40 includes a control unit 41, a resource-information storage unit 43, and a communication unit 44. The control unit 41 provides the functions of the terminal apparatus 40 and performs control related to the functions. The control unit 41 may includes, for example, one or more processors and storage media. The processors may read programs stored in a storage medium and execute the read programs to implement the functions of the control unit 41 described below.

The control unit 41 implements the functions of the terminal apparatus 40 and performs control related to control of the functions. The control unit 41 controls the operation of the communication unit 44, that is, performs processing related to communication with the relay station apparatus 10. For example, the control unit 41 performs processing for connecting to the relay station apparatus 10, control for receiving data (downstream) transmitted from the relay station apparatus 10 (for example, including demodulation and decoding), control for transmitting transmission data (upstream) to the relay station apparatus 10 (for example, including coding and modulation), allocating resources for communication with the relay station apparatus 10, and control of the carrier frequency of the communication unit 44.

The control unit 41 includes a communication-volume control unit 411. When the communication-volume control unit 411 receives data-rate change instruction information from the relay station apparatus 10 using the communication unit 44, the communication-volume control unit 411 extracts resource information contained in the data-rate change instruction information and stores the extracted resource information in the resource-information storage unit 43. The communication-volume control unit 411 generates acknowledgement information (ACK) indicating acceptance of a change in communication volume and transmits the generated acknowledgement information to the relay station apparatus 10 as a response to the generated data-rate change instruction information using the communication unit 44. The control unit 41 reads the resource information stored in the resource-information storage unit 43 and communicates with the relay station apparatus 10 using the resources indicated by the read resource information.

If the data-rate change instruction information contains the MCS value, the communication-volume control unit 411 may extract the MCS value and stores the extracted MCS value in the resource-information storage unit 43 in association with the resource information. The control unit 41 reads the MCS value stored in the resource-information storage unit 43, codes transmission data using a coding scheme indicated by the read MCS value, and decodes the demodulated received data using a decoding scheme corresponding to the coding scheme. The control unit 41 modulates the coded transmission data using a modulation scheme indicated by the MCS value and demodulates the received data using a demodulation scheme corresponding to the modulation scheme.

The resource-information storage unit 43 stores the resource information indicating resources allocated to communication with the relay station apparatus 10.

The communication unit 44 transmits and receives various data to and from the relay station apparatus 10 in the coverage of the terminal apparatus 40 wirelessly using a predetermined wireless communication system. The communication unit 44 includes a transmission unit 441 and a reception unit 442. The transmission unit 441 wirelessly transmits transmission data (upstream) input from the control unit 41 to the relay station apparatus 10 using an antenna. The reception unit 442 receives data (downstream) transmitted wirelessly from the relay station apparatus 10 with an antenna and outputs the received data to the control unit 41. The communication unit 44 includes, for example, a wireless communication interface.

Next, an example of communication processing according to the present embodiment will be described. FIG. 6 is a sequence chart illustrating an example of the communication processing according to the present embodiment. The processing illustrated in FIG. 6 is started when the terminal apparatus 40 is communicating with the first base station apparatus 20 via the relay station apparatus 10, in which the first base station apparatus 20 and the second base station apparatus 30 respectively serve as a source base station apparatus and a destination base station apparatus.

Step S102: The measurement instruction unit 211 of the first base station apparatus 20 generates measurement control information (Measurement Control) and transmits the generated measurement control information to the relay station apparatus 10.

Step S104: The first communication control unit 111 of the relay station apparatus 10 measures the reception quality of a reference signal received from each base station apparatus in accordance with the measurement control information received from the first base station apparatus 20. The first communication control unit 111 determines whether the reception quality satisfies the HO conditions that the measurement control information indicates, and if yes, generates measurement report (Measurement Report) indicating the measurement result of each reference signal. The first communication control unit 111 transmits the generated measurement report to the first base station apparatus 20.

Step S106: The second communication control unit 112 of the relay station apparatus 10 reduces the amount of resources to be allocated to the terminal apparatus 40 and generates data-rate change instruction information indicating an instruction to reduce the communication volume, including resource information indicating the reduced resources. The second communication control unit 112 transmits the generated data-rate change instruction to the terminal apparatus 40.

Step S108: When the communication-volume control unit 411 of the terminal apparatus 40 receives the data-rate change instruction information from the relay station apparatus 10, the communication-volume control unit 411 stores the resource information contained in the data-rate change instruction information in the resource-information storage unit 43. The communication-volume control unit 411 generates acknowledgement information (ACK) indicating acceptance of the change in communication volume and transmits the generated acknowledgement information to the relay station apparatus 10. Thereafter, the communication between the relay station apparatus 10 and the terminal apparatus 40 is continued, with the data rate reduced by using the allocated resources.

Step S110: The determination unit 212 of the first base station apparatus 20 determines a base station apparatus that satisfies the HO conditions as the destination base station apparatus and specifies the second base station apparatus 30 from the measurement result for each reference signal, indicated by the measurement report received from the relay station apparatus 10 to execute CHO.

Step S112: The request unit 213 of the first base station apparatus 20 generates CHO request information indicating an instruction to execute CHO and transmits the generated CHO request information to the second base station apparatus 30.

Step S114: When the request acceptance unit 311 of the second base station apparatus 30 receives the CHO request information from the first base station apparatus 20, the request acceptance unit 311 performs CHO acceptance processing.

Step S116: On completion of the CHO acceptance processing, the request acceptance unit 311 of the second base station apparatus 30 transmits CHO acknowledgement information to the first base station apparatus 20.

Step S118: When the instruction unit 214 of the first base station apparatus 20 receives the CHO acknowledgement information from the second base station apparatus 30, the instruction unit 214 generates CHO instruction information indicating an instruction for CHO to the second base station apparatus 30 and transmits the generated CHO instruction information to the relay station apparatus 10.

Step S120: When the first communication control unit 111 of the relay station apparatus 10 receives the CHO acknowledgement information indicating an instruction for CHO from the first base station apparatus 20, the first communication control unit 111 performs processing for connecting to the second base station apparatus 30.

Step S122: After completion of the processing for connecting to the second base station apparatus 30, the first communication control unit 111 of the relay station apparatus 10 transmits CHO-completion notification information indicating the completion of the CHO processing to the second base station apparatus 30.

Step S124: When the connection unit 312 of the second base station apparatus 30 receives the CHO-completion notification information from the relay station apparatus 10, the connection unit 312 transmits CHO completion report information indicating the completion of the CHO processing to the first base station apparatus 20.

Step S126: When the instruction unit 214 of the first base station apparatus 20 receives the CHO completion report information from the second base station apparatus 30, the instruction unit 214 transmits (transfers) transmission and reception status information (SN Status Transfer) indicating the status of transmission and reception of various data to and from the terminal apparatus 40 to the second base station apparatus 30.

Step S128: Thereafter, the relay station apparatus 10 and the second base station apparatus 30 starts communication therebetween.

Step S130: The second communication control unit 112 of the relay station apparatus 10 increases the amount of resources to be allocated to the communication with the terminal apparatus 40 to the amount before the start of the CHO processing and generates data-rate change instruction information indicating an instruction to reduce the communication volume, including resource information indicating the increased resources. The second communication control unit 112 transmits the generated data-rate change instruction information to the terminal apparatus 40.

Step S132: When the communication-volume control unit 411 of the terminal apparatus 40 receives the data-rate change instruction information from the relay station apparatus 10, he communication-volume control unit 411 stores the resource information contained in the data-rate change instruction information to the resource-information storage unit 43. The communication-volume control unit 411 generates acknowledgement information (ACK) indicating acceptance of the change in communication volume and transmits the generated acknowledgement information to the relay station apparatus 10. Thereafter, the communication between the relay station apparatus 10 and the terminal apparatus 40 is continued, with the data rate increased to the amount before the start of the CHO processing by using the allocated resources.

### Second Embodiment

Next, the difference between the first embodiment and a second embodiment of the present disclosure will be mainly described. The same functions and configurations as those of the first embodiment are given the same reference signs, and descriptions thereof will be quoted unless otherwise specified. When the request acceptance unit 311 of the second base station apparatus 30, which is the destination base station apparatus, receives CHO request information from the first base station apparatus 20, the request acceptance unit 311 performs CHO acceptance processing. In the CHO acceptance processing, the amount of unused resources that can be allocated or permitted to be allocated (hereinafter, referred to as “the amount of unused resources) can be insufficient for communication with the relay station apparatus 10. In that case, the request acceptance unit 311 may fail in the CHO acceptance processing, resulting in failing in continuing the communication from the terminal apparatus 40 via the relay station apparatus 10 in the communication system 1.

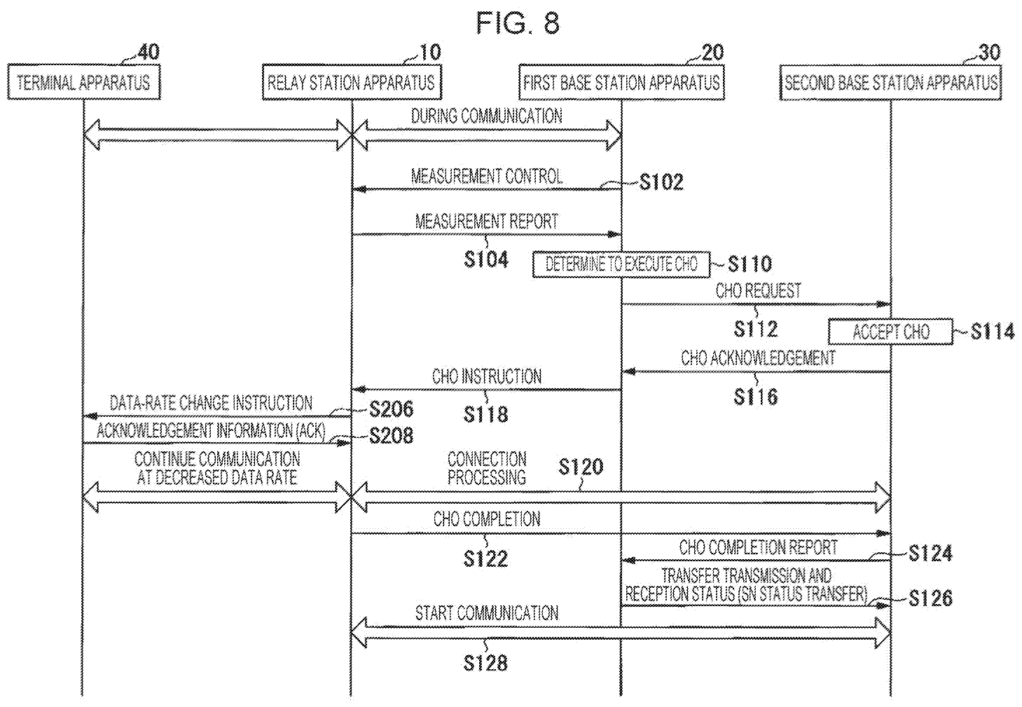

Next, an example of communication processing according to the present embodiment will be described. FIG. 8 is a sequence chart illustrating an example of the communication processing according to the present embodiment. The processing illustrated in FIG. 8 includes processing steps S102, S104, S110, S112, S114, S116, S118, S120, S120, S122, S124, S126, S128, S206, and S208. However, in the process illustrated in FIG. 8, the processing steps S106, S108, S130, and S132 illustrated in FIG. 6 are omitted.

In the example illustrated in FIG. 8, at step S112, the request unit 213 of the first base station apparatus 20 generates CHO request information including resource request information indicating a request for the amount of resources allocated to communication with the relay station apparatus 10 at that time. The request unit 213 transmits the generated CHO request information to the second base station apparatus 30.

At step S114 at which the request acceptance unit 311 performs CHO acceptance processing, the request acceptance unit 311 extracts the resource request information from the CHO request information and determines whether the requested resource amount indicated by the extracted resource request information is equal to or less than an unused resource amount. If the request acceptance unit 311 determines that the requested resource amount is equal to or less than the unused resource amount, the subsequent processes are performed as in the first embodiment. If the request acceptance unit 311 determines that the requested resource amount is larger than the unused resource amount, the request acceptance unit 311 allocates an amount of resources equal to or less than the amount of unused resources to the communication with the relay station apparatus 10.

At step S116, the request acceptance unit 311 generates CHO acknowledgement information including resource information including resource information indicating the allocated resources and data-rate change instruction information indicating an instruction to reduce the communication volume corresponding to the reduction in the amount of resources. The request acceptance unit 311 transmits the generated CHO acknowledgement information to the first base station apparatus 20.

At step S118, the instruction unit 214 of the first base station apparatus 20 extracts the resource information and the data-rate change instruction information contained in the CHO acknowledgement information received from the second base station apparatus 30. The instruction unit 214 transmits CHO instruction information including the extracted resource information and data-rate change instruction information to the relay station apparatus 10.

At step S206, the first communication control unit 111 of the relay station apparatus 10 extracts the data-rate change instruction information from the CHO instruction information received from the first base station apparatus 20 and outputs the data-rate change instruction information to the second communication control unit 112. The second communication control unit 112 reduces the resources to be allocated to each of the terminal apparatuses 40 from the amount before the start of the CHO processing so that the total communication volume becomes equal to or less than a communication volume corresponding to the amount of resources indicated by the data-rate change instruction information input from the first communication control unit 111. The total communication volume refers to the sum of the communication volumes of the terminal apparatuses 40 connected to the relay station apparatus 10. The second communication control unit 112 generates data-rate change instruction information indicating an instruction to reduce the communication volume including the resource information indicated the reduced resources. The second communication control unit 112 transmits the generated data-rate change instruction to each of the terminal apparatuses 40.

At step S208, when the communication-volume control unit 411 of the terminal apparatus 40 receives the data-rate change instruction information from the relay station apparatus 10, the communication-volume control unit 411 stores the resource information contained in the data-rate change instruction information in the resource-information storage unit 43. The communication-volume control unit 411 generates acknowledgement information (ACK) indicating acceptance of the change in communication volume and transmits the generated acknowledgement information to the relay station apparatus 10. Thereafter, the communication between the relay station apparatus 10 and the terminal apparatus 40 is continued, with the data rate reduced by using newly allocated resources. Thus, the total communication volume of the relay station apparatus 10 and the terminal apparatus 40 becomes equal to or less than a communication volume corresponding to the resources that can be allocated to the communication between the relay station apparatus 10 and the destination second base station apparatus 30. This may prevent a failure in CHO, allowing the communication from the terminal apparatus 40 via the relay station apparatus 10 to be continued more reliably.

### Third Embodiment

Next, the difference between the first embodiment and a third embodiment of the present disclosure will be mainly described. The same functions and configurations as those of the first embodiment are given the same reference signs, and descriptions thereof will be quoted unless otherwise specified. In the present embodiment, normal handover (HO) is employed instead of the conditional handover (CHO) exemplified in the first embodiment. The normal HO differs from the CHO in that the second base station apparatus 30 allocates resources for communication with the relay station apparatus 10 after completion of processing for connecting to the relay station apparatus 10.

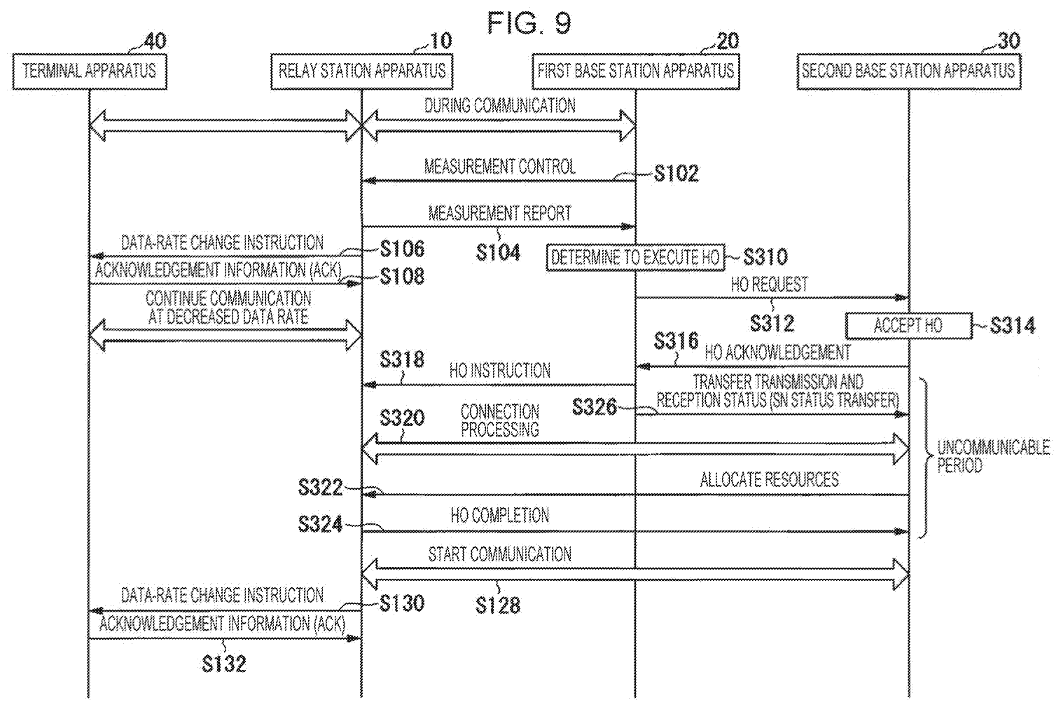

Next, an example of the communication processing according to the present embodiment will be described. FIG. 9 is a sequence chart illustrating an example of the communication processing according to the present embodiment. The processing illustrated in FIG. 9 includes processing steps S102, S104, S106, S108, S126, S128, S130, S132, S310, S312, S314, S316, S318, S320, S322, and S324. However, in the processing illustrated in FIG. 9, the processing steps S110, S112, S114, S116, S118, S120, S122, and S124 illustrated in FIG. 6 are omitted.

At step S310, the determination unit 212 of the first base station apparatus 20 determines a neighboring base station apparatus of a cell that is the transmission source of a reference signal whose reception quality satisfies the HO conditions from the measurement result of each reference signal, shown in the measurement report received from the relay station apparatus 10, as a destination base station apparatus and specifies the second base station apparatus 30 to execute HO.

At step S312, the request unit 213 of the first base station apparatus 20 generates HO request information indicating an instruction to execute HO and transmits the generated HO request information to the second base station apparatus 30.

At step S314, when the request acceptance unit 311 of the second base station apparatus 30 receives the HO request information from the first base station apparatus 20, the request acceptance unit 311 performs HO acceptance processing.

At step S316, upon completion of the HO acceptance processing, the request acceptance unit 311 of the second base station apparatus 30 transmits HO acknowledge information to the first base station apparatus 20. Since the HO acceptance processing does not include processing for allocating resources for use in the communication with the relay station device 10, the request acceptance unit 311 does not include resource information in the HO acknowledge information.

At step S318, when the instruction unit 214 of the first base station apparatus 20 receives the HO acknowledge information from the second base station apparatus 30, the instruction unit 214 generates HO instruction information indicating an instruction for the second base station apparatus 30 to execute HO and transmits the generated HO instruction information to the relay station device 10.

At step S326, the instruction unit 214 transmits (transfers) transmission and reception status information (SN Status Transfer) indicating the transmission and reception status of various data to and from the terminal device 40 to the second base station apparatus 30.

At step S320, when the first communication control unit 111 of the relay station apparatus 10 receives the HO acknowledgement information indicating an instruction for HO from the first base station apparatus 20, the first communication control unit 111 performs processing for connecting to the second base station apparatus 30. At step S322, the control unit 31 of the second base station apparatus 30 allocates resources for use in communication with the relay station apparatus 10 and transmits resource information indicating the allocated resources to the relay station apparatus 10.

At step S324, when the first communication control unit 111 of the relay station apparatus 10 receives the resource information from the second base station apparatus 30, the first communication control unit 111 transmits HO completion notification information indicating completion of the HO processing to the second base station apparatus 30. At step S128, the relay station apparatus 10 starts communication with the second base station apparatus 30 using the resources indicated by the resource information received from the second base station apparatus 30.

Since the relay station apparatus 10 is generally unable to communicate with either of the source base station apparatus and the destination base station apparatus during HO processing, data that the relay station apparatus 10 received from the terminal apparatus 40 is retained at the relay station apparatus 10. In the processing illustrated in FIG. 9, the period between the start of the processing of step S318 and the end of the processing of step S324 corresponds to an uncommunicable period. In the present embodiment, the amount of communication between the relay station apparatus 10 and the terminal apparatuses 40 during HO processing reduces from the volume before the HO processing, and after completion of the HO processing, the reduced communication volume increases to the communication volume before the HO processing. This reduces the amount of received data retained at the relay station apparatus 10 during the HO processing, thereby allowing smoothly resuming the communication between the relay station apparatus 10 and the second base station apparatus 30, which is the destination base station apparatus, after the HO processing.

In the above embodiments, when the relay station apparatus 10 is connected to a plurality of terminal apparatuses 40 at the start of CHO processing or HO processing (hereinafter collectively referred to as CHO processing or the like), the second communication control unit 112 of the relay station apparatus 10 may reduce the communication volume for all of the terminal apparatuses 40 at an equal ratio (for example, one half or one fourth of the communication volume before the CHO processing or the like). However, this is given for mere illustrative purposes. The change ratio of the communication volume may differ among the terminal apparatuses 40. The second communication control unit 112 may reduce the communication volume so as to obtain an equal throughput for all of the terminal apparatuses 40, that is, an effective maximum transmission speed (for example, 10 Mbps or 20 Mbps).

The second communication control unit 112 may restore the communication volume allocated to each terminal apparatus 40 immediately after completion of the CHO processing or the like to the initial communication volume immediately or stepwise. “Restore the initial communication volume stepwise” refers to gradually bringing the reduced communication volume close to the initial communication volume over a period longer than the normal resource allocation period during communication (for example, 5 to 50 ms). When gradually bringing the reduced communication volume close to the initial communication volume, the second communication control unit 112 may continuously increase the communication volume with time during the period or repeat the processing for increasing the communication volume for a plurality of times during the period (the amount of change in communication volume per time is set to be smaller than the difference between the initial communication volume and the reduced communication volume). This may prevent congestions that can be caused by a sharp increase in communication volume.

As described above, the relay station apparatus 10 according to the above embodiments includes communication units (for example, the first communication unit 14 and the second communication unit 15) that respectively communicate with the terminal apparatus 40 and the base station apparatus wirelessly, the first communication control unit 111 that controls the communication with the terminal apparatus 40, and the second communication control unit 112 that controls the communication with the terminal apparatus 40. The first communication control unit 111 measures the radio environment on the basis of measurement control information received from the base station apparatus (for example, the first base station apparatus 20) and determines whether to change the base station apparatuses to be used for communication on the basis of the measurement result of the radio environment. If the first communication control unit 111 determines that the base station apparatuses needs to be changed, the first communication control unit 111 starts processing for changing the base station apparatuses (for example, CHO processing or HO processing). The second communication control unit reduces the communication volumes of the terminal apparatuses 40 during the processing of changing the base station apparatuses. This configuration reduces the amount of resources to be reserved in the destination base station apparatus in the processing of changing the base station apparatuses, thereby increasing the possibility of successful change of the base station apparatuses. This configuration also reduces the amount of data retained at the relay station apparatus 10 even if the communication with the terminal apparatuses 40 is continued during the processing for changing the base station apparatuses, thereby allowing smoothly starting communication with the destination base station apparatus.

When the first communication control unit 111 determines that the base station apparatuses need to be changed, the second communication control unit 112 may transmit a communication volume change instruction (for example, data-rate instruction information) to reduce the volume of communication with the terminal apparatuses 40 to the terminal apparatuses 40. This configuration allows instructing the terminal apparatuses 40 to reduce the communication volume at the point where a determination to change the base station apparatuses is made, thereby further reducing the amount of data retained at the relay station apparatus 10.

When the first communication control unit 111 determines that the base station apparatuses need to be changed, the second communication control unit 112 transmits measurement report indicating the measurement result to the source base station apparatus in communication, and when the first communication control unit 111 receives a base station apparatus change instruction (for example, CHO instruction information) to change the base station apparatuses from the source base station apparatus, the first communication control unit 111 transmits a communication volume change instruction to change the volume of communication with the terminal apparatuses 40 to the terminal apparatuses 40. This configuration allows starting to reduce data amount more reliably at the time when the base station apparatuses are changed by transmitting the base station apparatus change instruction after the destination base station apparatus accepts the change of base station apparatuses (for example, CHO acceptance) requested by the source base station apparatus. This reduces the period for reducing the data amount. Furthermore, this configuration allows the communication with the terminal apparatuses 40 within the range of allocatable communication volume by the destination base station apparatus notifying the relay station apparatus 10 of the allocatable communication volume together with the base station apparatus change instruction. This allows changing the base station apparatuses more reliably to continue the communication from the terminal apparatuses 40 via the relay station apparatus 10.

When the second communication control unit 112 reduces the volume of communication with the terminal apparatuses 40, the second communication control unit 112 may make the information density of communication data related to the communication with the terminal apparatuses 40 higher than the information density before the base station apparatus change processing (for example, increasing the MCS value). This configuration allows substantially eliminating or minimizing the reduction in the amount of information of transferred communication data even if the amount of resources to be allocated is reduced.

Furthermore, when the second communication unit 15 is connected to a plurality of terminal apparatuses 40, the second communication control unit 112 may reduce the communication volume at the same ratio among the terminal apparatuses 40 or so as not to exceed the same throughput among the terminal apparatuses 40. This configuration reduces the volumes of communication data transmitted among the plurality of terminal apparatuses 40 connected.

When the base station apparatus change processing is completed, the second communication control unit 112 may recover the volume of communication with the terminal apparatuses 40 to the communication volume before the base station apparatus change processing. This configuration allows performing the same volume of communication after the base station apparatus change processing as before the change processing, thereby limiting the influence of the reduction in communication volume during the base station apparatus change processing.

The second communication control unit 112 gradually changes the volume of communication with the terminal apparatuses 40 from the communication volume at the completion of the base station apparatus change processing to the communication volume before the change processing. With this configuration, the volume of communication between the destination base station apparatus and the relay station apparatus 10 gradually increases from the completion of the change processing to the communication volume before the change processing. This may prevent congestions due to a sharp increase in communication volume.

Having described the embodiments of the present disclosure with reference to the drawing, it is to be understood that the present disclosure is not limited to the specific embodiments and that various changes in design and so on may be made without departing from the spirit and scope of the present disclosure. For example, in increasing the information density of communication data related to the communication between the relay station apparatus 10 and the terminal apparatuses 40, the MCS value is increased. This is given for mere illustrative purposes. In increasing the information density, the second communication control unit 112 of the relay station apparatus 10 and the control unit 41 of the terminal apparatus 40 may execute either one of increasing the ratio of coding and decoding and increasing the modulation multi-level number in modulation and demodulation. When the control unit 31 of the second base station apparatus 30, which is the destination base station apparatus, reduces the volume of communication data related to the communication with the relay station apparatus 10, the control unit 31 of the second base station apparatus 30 and the first communication control unit 111 of the relay station apparatus 10 may increase the information density of the communication data.

The terminal apparatuses 40 are not limited to information communication apparatuses such as mobile phones (including what-is-called smartphones), tablet terminal apparatuses, and personal computers and may be various types of electronic apparatus or measuring instrument (for example, thermometers, pressure gauges, and speedometers). The relay station apparatus 10 may include one or more antennas common to the first transmission unit 141 and the first reception unit 142 or may include one or more antennas for each of them. The relay station apparatus 10 may include one or more antennas common to the second transmission unit 151 and the second reception unit 152 or may include one or more antennas for each of them. The relay station apparatus 10 may include an antenna common to all of the first transmission unit 141, the first reception unit 142, the second transmission unit 151, and the second reception unit 152. The first base station apparatus 20 may include one or more antennas common to the transmission unit 241 and the reception unit 242 or may include one or more antennas for each of them. The second base station apparatus 30 may include one or more antennas common to the transmission unit 341 and the reception unit 342 or may include one or more antennas for each of them. The terminal apparatus 40 may include one or more antennas common to the transmission unit 441 and the reception unit 442 or may include one or more antennas for each of them.

The present disclosure contains subject matter related to that disclosed in Japanese Priority Patent Application JP 2018-237438 filed in the Japan Patent Office on Dec. 19, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A relay station apparatus comprising:
a communication unit configured to wirelessly communicate with a terminal apparatus and a base station apparatus, respectively;
a first communication control unit configured to control communication with the base station apparatus; and
a second communication control unit configured to control communication with the terminal apparatus,
wherein the first communication control unit
measures a radio environment based on measurement control information received from the base station apparatus,
determines whether to change the base station apparatus based on a measurement result of the radio environment, and
when determining that the base station apparatus need to be changed, starts processing for changing the base station apparatus, and
wherein the second communication control unit reduces a volume of communication with the terminal apparatus during the processing for changing the base station apparatus from a communication volume before the processing for changing the base station apparatus.

2. The relay station apparatus according to claim 1, wherein, when the first communication control unit determines that the base station apparatus needs to be changed, the second communication control unit transmits a communication volume change instruction to reduce the volume of communication with the terminal apparatus to the terminal apparatus.

3. The relay station apparatus according to claim 1,
wherein, when the first communication control unit determines that the base station apparatus needs to be changed, the second communication control unit transmits a measurement report indicating the measurement result to the base station apparatus, and
wherein, when the second communication control unit receives a base station apparatus change instruction to change the base station apparatus from the base station apparatus, the second communication control unit transmits a communication volume change instruction to reduce the volume of communication with the terminal apparatus to the terminal apparatus.

4. The relay station apparatus according to claim 2, wherein, when the second communication control unit reduces the volume of communication with the terminal apparatus, the second communication control unit increases an information density of communication data related to the communication with the terminal apparatus as compared with the volume of communication before the change processing.

5. The relay station apparatus according to claim 4, wherein, when the communication unit is connected to a plurality of terminal apparatuses, the second communication control unit reduces the volume of communication at a ratio common to the plurality of terminal apparatuses or not to exceed a throughput common to the plurality of terminal apparatuses.

6. The relay station apparatus according to claim 1, wherein, when processing for changing the base station apparatus is completed, the second communication control unit recovers the volume of communication with the terminal apparatus to a communication volume before the change processing.

7. The relay station apparatus according to claim 6, wherein the second communication control unit gradually brings the volume of communication with the terminal apparatus from the volume of communication at completion of the change processing close to the communication volume before the change processing.

8. A communication system comprising:
a relay station apparatus; and
a base station apparatus,
wherein the relay station apparatus includes:
a first communication control unit configured to control communication with the base station apparatus; and
a second communication control unit configured to control communication with the terminal apparatus,
wherein the first communication control unit
measures a radio environment based on measurement control information received from the base station apparatus,
determines whether to change the base station apparatus based on a measurement result of the radio environment, and
when determining that the base station apparatus need to be changed, starts processing for changing the base station apparatus, and
wherein the second communication control unit reduces a volume of communication with the terminal apparatus during the processing for changing the base station apparatus from a communication volume before the processing for changing the base station apparatus.

9. A method of communication for a relay station apparatus including a communication unit configured to wirelessly communicate with a terminal apparatus and a base station apparatus, respectively, the method comprising:
the relay station apparatus measuring a radio environment based on measurement control information received from the base station apparatus,
the relay station apparatus determining whether to change the base station apparatus based on a measurement result of the radio environment, and
when determining that the base station apparatus need to be changed, the relay station apparatus starting processing for changing the base station apparatus, and
the relay station apparatus reducing a volume of communication with the terminal apparatus during the processing for changing the base station apparatus from a communication volume before the processing for changing the base station apparatus.
